(19) United States
(12) Patent Application Publication
(10) Pub. No.: US 2011/0080639 A1
(43) Pub. Date: Apr. 7, 2011

(54) METHOD AND APPARATUS FOR DISPLAYING 3-DIMENSIONAL IMAGES INCORPORATING ANGULAR CORRECTION

(76) Inventor: Bradley Nelson, Castaic, CA (US)

(21) Appl. No.: 12/851,530

(22) Filed: Aug. 5, 2010

Related U.S. Application Data
(60) Provisional application No. 61/231,390, filed on Aug. 5, 2009.

(51) Int. Cl. G02B 27/26; G02B 27/22

(52) U.S. Cl. 359/465; 359/464

(57) ABSTRACT

A technique for encoding a three dimensional image formatted according to a three dimensional format is disclosed. The technique employs a surface or surfaces for encoding a three dimensional image to create a left view image and a right view image. The surface or surfaces may include an arrangement of encoding stripes, black ink stripes, and transparent stripes. The stripes may be arranged in a vertical, horizontal, or checkerboard pattern. The black ink stripes may be further arranged in a manner that corrects an angular viewing error. The encoded right view and left view images are decoded by a left lens and a right lens, respectively, of a pair of polarized 3D viewing glasses worn by a viewer.

### RELATED APPLICATIONS

This application claims priority, under 35 U.S.C. §119(e), to U.S. Provisional Application No. 61/231,390, filed August 5, 2009, which is expressly incorporated herein by reference.

### BACKGROUND OF THE INVENTION

1. Field of the Invention

The invention generally relates to an enhanced technique for viewing a three dimensional image. More particularly, the invention relates to an apparatus and method for using a surface or surfaces for encoding a three dimensional image calibrated to optimize the viewing angle of the three dimensional image displayed.

2. Background and Related Prior Art

Stereoscopic display systems attempt to recreate a real world visual experience wherein a viewer sees a different view or image in each eye. In a real world viewing experience, a viewer with two eyes sees two slightly different images, as the viewer's eyes are spaced slightly apart from one another. A goal of stereoscopic video display systems is to present a separate and different view to each eye of the viewer.

Multiple attempts at replicating a real world viewing experience are known in the related art. In the prior art, the application of encoding material onto a fragile glass substrate that must be permanently laminated to the front of the monitor screen is in use. The known techniques in the prior art failed to consider the potential benefit of retrofitting existing televisions and monitors to achieve a 3D viewing experience. The prior art was focused upon creating a 3D viewing experience using a permanent and expensive method to achieve the 3D stereoscopic effect. Further, prior art techniques do not correct distortions near the edges of image displays caused by spacing between the display screen and the film or substrate that creates the 3D image.

### BRIEF SUMMARY OF THE INVENTION

The embodiments disclosed herein overcome shortfalls in the related art by presenting an unobvious and unique configuration of the arrangement of encoding, black, and transparent stripes in a horizontal line, vertical line, checkerboard or other interleaved pattern on a flexible laminate film to the front of existing display systems in the market place. The display systems receive a 3D-formatted image and displayed it via a series of light emitting pixels. The encoding stripes encode the light emitted by a row or rows of pixels for viewing through a right or left decoding lens. The transparent stripes allow separate layers of right and left encoding stripes to be combined without obstructing any portion of either layer. The black ink stripes obstruct pixels from a pixel row adjacent to an encoded pixel row from being inadvertently encoded and causing distortions. By arranging the black stripes in a manner that accounts for spacing between the film and the pixels comprising the 3D image (which, unaccounted for, would result in distortions in the 3D image quality), a more uniform picture and a wider viewing angle is achieved. Using pairs of lines or pixels for the width of the encoding elements reduces the precision required to align the film, making it possible for consumers to apply the film to their display. Many different types of displays can be retrofitted in this way, including, but not limited to cell phones, Blackberrys, computer monitors, video monitors, and televisions.

In one embodiment, circular or linear encoding material with alternating horizontal rows of right or left eye viewing channels is used. The use of complementary linear or circular decoding viewing glasses creates a left eye viewing channel through light exiting through one horizontal row of encoding stripes and a right eye viewing channel through another horizontal row of encoding stripes. Each of the rows of left or right encoding material may be one or more vertical pixel lines wide.

In a second embodiment, circular or linear encoding material with alternating vertical rows of right or left eye viewing channels is used. The use of complementary linear or circular decoding viewing glasses creates a left eye viewing channel through light exiting through one vertical row of encoding stripes and a right eye viewing channel through another vertical row of encoding stripes. Each of the rows of left or right encoding material may be one or more horizontal pixels wide.

In a third embodiment, circular or linear encoding material with a checkerboard of right or left eye viewing channels is used. The use of complementary linear or circular decoding viewing glasses creates a left eye viewing channel through light exiting through one series of vertical encoding sections and a right eye viewing channel through another series of vertical encoding sections. Each of the checkerboards of left or right encoding material may be one or more horizontal pixels wide and two or more vertical pixels high.

In each of the above embodiments, the right and left eye viewing channels may be disposed on separate layers or on a single layer. In the embodiments wherein the right and left eye viewing channels are disposed on separate layers, each layer includes alternating stripes of encoding ink and transparency. In the embodiments wherein the right and left viewing channels are disposed on a single layer, the layer includes alternating stripes of right and left view encoding ink. An example of a product incorporating a single layer a configuration is the μPol™ line of stereoscopic imaging accessories.

Additionally, these unique arrangements of encoding materials are not compatible with all of the current 3D formats of content in the marketplace. This helps to maintain separation of the left and right view information when passed through current video compression algorithms and will allow for secure encoding and decoding of content distribution including but not limited to broadcasts, internet, cellular transmissions, and HD or standard video discs.

The encoding material may encode the three dimensional image by polarizing light from the pixels for viewing through a pair of polarized 3D viewing glasses. In such embodiments, the encoding stripes are formed by applying polarization ink to the encoding material, wherein each encoding stripe is calibrated to encode a left or right view. The resulting left and right views are decoded by the left and right lenses, respectively, of the polarized 3D viewing glasses as described above to achieve the 3D viewing effect.

Alternatively, the encoding material may encode the three dimensional image through quarter wave retardation of polarized light emitted by an LCD display. Most commercially available LCD systems include a polarizer that polarizes displayed images linearly, but not circularly. Circular polarization is necessary for 3D viewing. In this embodiment, quarter wave retardation technology takes advantage of the built-in linear polarization capability of LCD systems by receiving linearly polarized light from the display and circularly polarizing it as necessary to achieve the 3D viewing effect. As in the aforementioned embodiments, each of the quarter wave retardation encoding stripes encodes the received image in left and right views, which are then decoded by the left and right lenses, respectively, of a pair of polarized 3D viewing glasses.

The black stripes are arranged along a layer or layers in accordance with a formula for correcting an angular error created by the change in viewing angle at the top, bottom, and sides of the display. None of the presently manufactured 3D displays compensate for this error. The disclosed method of compensation helps to maintain the correct left and right views of the 3D content being displayed on the screen. The result is a more uniform picture and a wider viewing angle.

These and other objects and advantages will be made apparent when considering the following detailed specification when taken in conjunction with the drawings.

### BRIEF DESCRIPTION OF THE DRAWINGS

FIG. 1A is a perspective view of an LCD display onto which a layer of left eye view encoding film 200, a layer of right eye view encoding film, and a transparent lamination layer will be affixed.

FIG. 1B is a perspective view of an LCD display onto which a layer of right and left eye encoding film will be affixed.

FIG. 2 is a perspective view of a pair of 3D eye glasses featuring decoding lenses.

FIG. 3 is a front plan view of the upper left-hand corner of the left and right encoding films showing the encoding, black ink, and transparent zones of the individual sheets before assembly.

FIG. 4 is a front plan view all of the film elements combined together and mounted on the display, in a horizontal line configuration.

FIG. 5 is a front plan view of all of the film elements combined together and mounted on the display, in a vertical line configuration.

FIG. 6 is a front plan view of all of the film elements combined together and mounted on the display, in a checkerboard configuration.

FIG. 7 is a diagram illustrating the steps of encoding and decoding the 3D-formatted image.

FIG. 8A is a diagram illustrating angular differentials between pixel row viewing angle and horizontal encoding stripe viewing angle wherein a viewer is positioned at a given distance x from an LCD screen.

FIG. 8B is a diagram illustrating angular differentials between pixel row viewing angle and horizontal encoding stripe viewing angle wherein a viewer is positioned at a given distance y from an LCD screen.

FIG. 9 is a side plan view of a diagram for calculating the angular error corrections for the positioning of the black ink masking stripes.

FIG. 10 is a side plan view of the position of the black ink masking stripe without the angular correction.

FIG. 11 is a side plan view of the position of the black ink masking stripe with the angular correction.

### DETAILED DESCRIPTION

### Overview

The embodiments disclosed herein overcome shortfalls in the related art by presenting a configuration of circular, linear or otherwise encoded light segregating coverings to existing liquid crystal display (LCD) or other types of display systems. The embodiments achieve innovative results through the modular use of encoding material creatively fastened over displays for displaying 3D image content.

Various embodiments present circular or linear encoding material with alternating rows of right or left eye viewing channels. The use of complimentary linear or circular decoding viewing lenses (hereinafter “3D glasses”) creates a right viewing channel through light exiting through a row of right view encoding stripes while a left eye viewing channel is created on a row of left view encoding stripes. When light from an illuminated pixel passes through a right view encoding stripe, the light is only viewable through the right lens of the 3D glasses worn by the viewer. When light from an illuminated pixel passes through a left view encoding stripe, the light is only viewable through the left lens of the 3D glasses worn by the viewer. The right and left lenses block any light passing thru left view encoding stripes and right view encoding stripes, respectively, creating the cancelation necessary to simulate a 3D image. Right and left view encoding stripes may be applied in alternating horizontal, vertical, or checkerboard arrangements and fastened over an existing LCD display system.

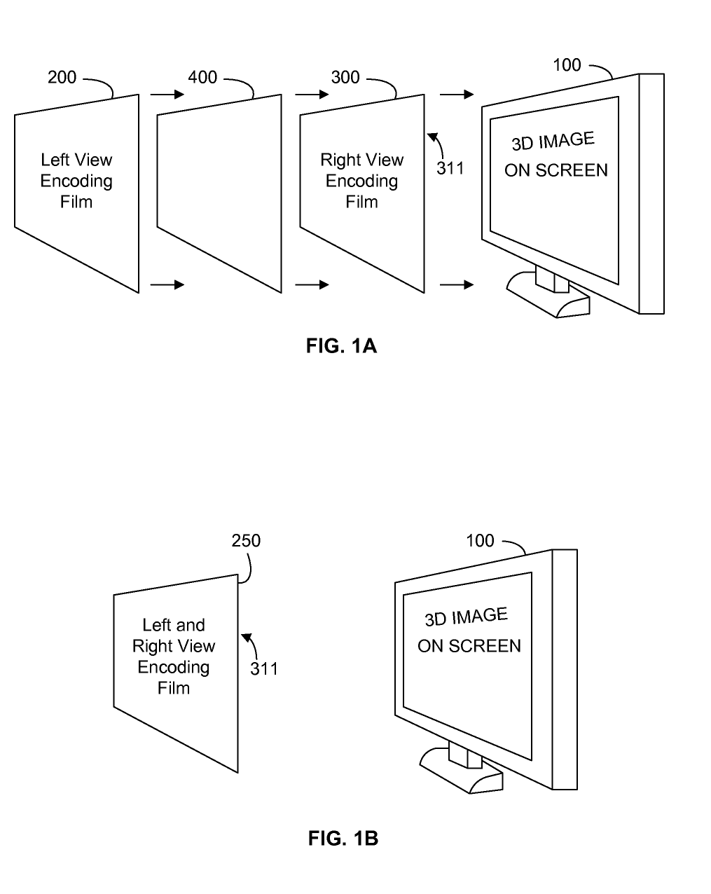

Two embodiments of an assembly of encoding material and an LCD screen display are depicted in FIGS 1A and 1B. In FIG. 1A, an image is generated on an LCD screen or panel 100. To generate the illusion of a 3-dimensional image, a series of layers is applied to the front of the display. These include a layer of left eye view encoding film 200 and a layer of right eye view encoding film 300 separated by a transparent lamination layer 400. The combination of layers is applied to the display using non-residue adhesive 311. In FIG. 1B, a single layer of encoding film 250 including right and left eye viewing channels is applied to the display using non-residue adhesive 311. In either embodiment, the non-residue adhesive 311 is applied to the screen facing side of the right eye view encoding film 300 or the single layer of encoding film 250 to hold the film to the display 100 in a way that can be easily applied and removed from the display.

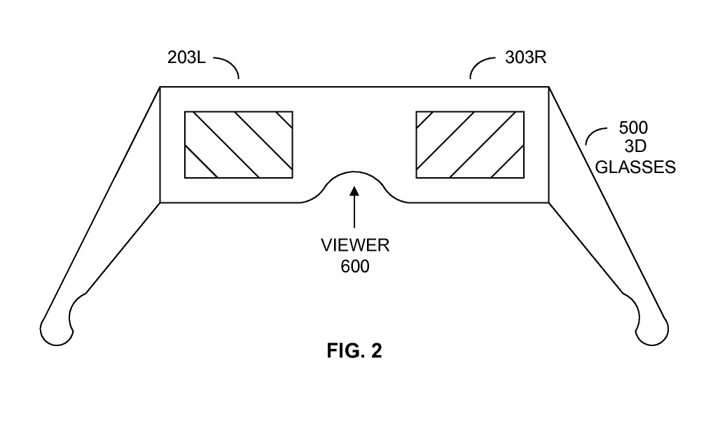

FIG. 2 depicts a pair of 3D glasses 500 including a right lens 303R and a left lens 203L. Lenses 303R and 203L may include means of circular or linear polarization that decodes a right or left view as described above. The 3D glasses may be constructed of disposable paper, plastic, or wire.

In order to replicate a real world viewing experience, the combined layers of film can be easily be applied or removed by the user. An alignment disc or transmission of an alignment pattern that depicts a clearly defined image for positioning the film to the front of the monitor aids the viewer with proper viewing of 3D content.

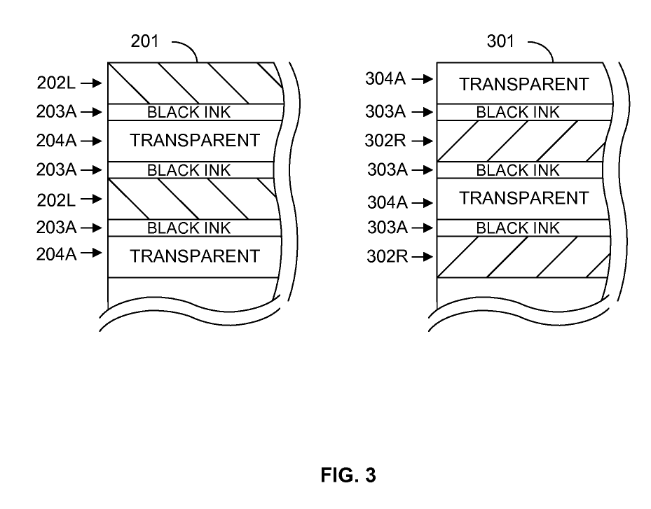

In each of the systems illustrated in FIG 1A and 1B, the left and right eye viewing channels include encoding stripes that create unique left and right eye views of an underlying image displayed on the screen 100. These channels are further illustrated in FIG. 3. FIG. 3 represents a front plan view of the upper left-hand corner of the left eye and right eye encoding films 201 and 301, respectively, showing encoding, black ink, and transparent zones of the individual layers of FIG. 1A before assembly. A left encoding stripe 202L is positioned at the top section of 201 and a transparent stripe 304A is positioned at the top section of 301. The left encoding stripe 202L is oriented such that it appears transparent when viewed through the left lens 203L and black when viewed thru the right lens 302R of the 3D glasses depicted in FIG. 2. The black ink stripes 203A of the left eye layer 201 are positioned in the same location as the black ink stripes 303A of the right eye layer 301; when these layers are laminated together, the black ink stripes 203A and 303A overlap. The transparent stripes 204A of the left eye layer 201 are positioned in the same location as the right encoding stripes 302R of the right eye layer 301; when these layers are laminated together, the transparent stripes 204A and the right encoding stripes 302R overlap. The left encoding stripes 202L of the left eye layer 201 are positioned in the same location as the transparent ink stripes 304A of the right layer 301; when these layers are laminated together, the left encoding stripes 202L and the transparent stripes 304A overlap. The right encoding stripes 302R are oriented such that they appear transparent when viewed thru the right lens 303R and black when viewed thru the left lens 203L of the 3D glasses depicted in FIG. 2. In embodiments incorporating a single layer of encoding material, right and left encoding stripes alternate with black ink stripes on the same layer; transparent stripes are unnecessary.

The encoding stripes may be disposed in a horizontal arrangement (as in FIG. 3), a vertical arrangement, or a checkerboard arrangement.

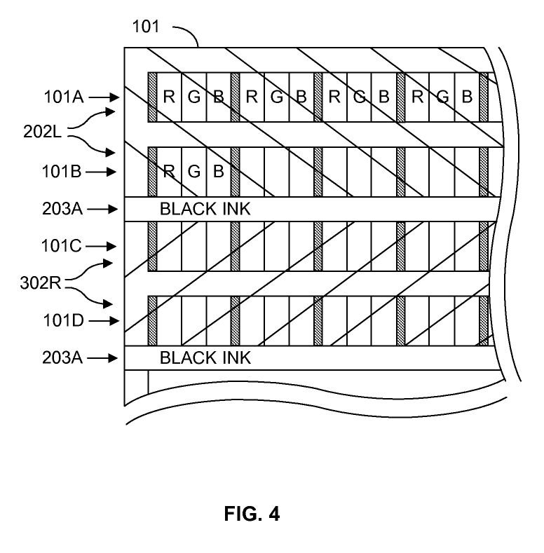

The horizontal arrangement is illustrated in further detail in FIG. 4. FIG. 4 represents a front plan view of a multi-layer embodiment of the type illustrated in FIG. 1A. Depicted in order from rear to front are the upper left-hand corner of the LCD display 101, the upper left-hand corner of the right hand encoding film 300, the upper left-hand corner of the transparent laminating film 400, and the upper left-hand corner of the left-hand encoding film 200. FIG. 4 shows the relationship between the pixels and encoding material for a horizontal arrangement of right and left view encoding stripes. The corresponding transparent areas of the film layers are not noted in this drawing. Also shown are 48 RGB pixel elements that, when combined together, form 16 single full color pixel elements. The 4 horizontal rows of pixels shown are labeled sequentially 101A-D. The right view encoding film 300 shows right view encoding stripes 302R covering pixel rows 101C and 101D; the black ink stripes 303A are hidden behind black ink stripes 203A and are not shown. The left view encoding film 202 shows the black ink stripes 203A and the left view encoding stripes 202L covering horizontal pixel rows 101A and 101B.

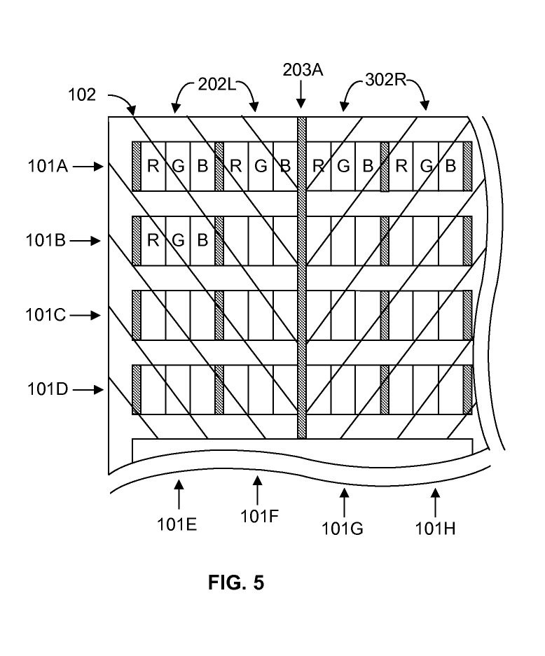

The vertical arrangement is illustrated in further detail in FIG. 5. FIG. 5 represents a front plan view of a multi-layer embodiment of the type illustrated in FIG. 1A. Depicted in order from rear to front are the upper left-hand corner of the LCD display 102, the upper left-hand corner of the right hand encoding film 300, the upper left-hand corner of the transparent laminating film 400, and the upper left-hand corner of the left-hand encoding film 200. FIG. 4 shows the relationship between the pixels and encoding material for a vertical arrangement of right and left view encoding stripes. The corresponding transparent areas of the film layers are not noted in this drawing. Also shown are 48 RGB pixel elements that, when combined together, form 16 single full color pixel elements. The four horizontal rows of pixels shown are labeled sequentially 101A-D and the four vertical rows of pixels shown are labeled sequentially 101E-H. The right view encoding film 300 shows right view encoding stripes 302R covering pixel rows 101G and 101H; the black ink stripes 303A are hidden behind black ink stripes 203A and are not shown. The left view encoding film 203 shows the black ink stripes 203A and the left view encoding stripes 202L covering vertical pixel rows 101E and 101F.

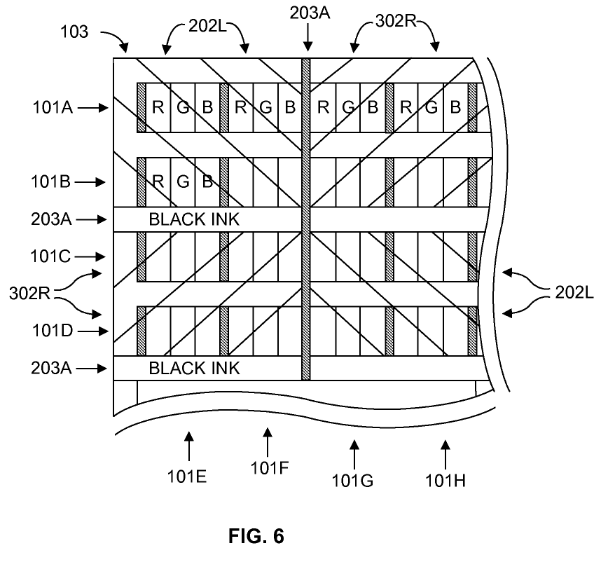

The checkerboard arrangement is illustrated in further detail in FIG. 6. FIG. 6 represents a front plan view of a multi-layer embodiment of the type illustrated in FIG. 1A. Depicted in order from rear to front are the upper left-hand corner of the LCD display 103, the upper left-hand corner of the right hand encoding film 300, the upper left-hand corner of the transparent laminating film 400, and the upper left-hand corner of the left-hand encoding film 200. FIG. 6 shows the relationship between the pixels and encoding material for a vertical arrangement of right and left view encoding stripes. The corresponding transparent areas of the film layers are not noted in this drawing. Also shown are 48 RGB pixel elements that, when combined together, form 16 single full color pixel elements. The four horizontal rows of pixels shown are labeled sequentially 101A-D and the four vertical rows of pixels shown are labeled sequentially 101E-H. The right view encoding film 300 shows the right view encoding strips 302R covering pixels at the intersection of 101A with 101G-H, 101B with 101G-H, 101C with 101E-F, and 101D with 101E-F; the black ink stripes 303A are hidden behind black ink stripes 203A and are not shown. The left-hand encoding film 200 shows the black ink stripes 203A and the encoding ink 202L covering pixels at the intersection of 101A with 101E-F, 101B with 101E-F, 101C with 101G-H and 101D with 101G-H.

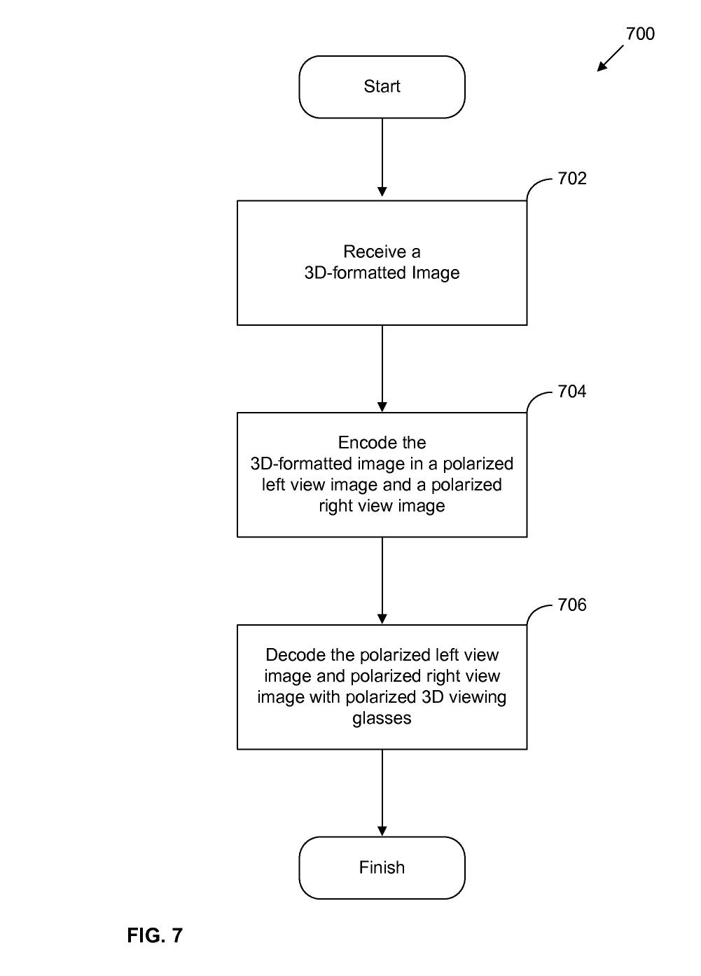

FIG. 7 depicts a flow chart 700 illustrating the procedure for encoding and decoding a 3D-formatted image. At step 702, the display receives a 3D-formatted image from a broadcaster or transmitter of video signals. At step 704, the 3D-formatted image is polarized in a left view image and a right view image. At step 706, the left view image and right view image are decoded with a pair of polarized 3d viewing glasses using a left lens and a right lens, respectively.

In each of the above-described embodiments, uniform spacing of the black stripes creates a 3D viewing experience that is, in one key respect, imperfect. Any technique for simulating a 3D image that comprises layering an existing display with one or more sheets of encoding material results in a encoding surface that is separated from the image pixels by the width of the screen glass. Thus, there exists a slight distance between a row of pixels and the encoding stripe layered directly over it. This distance causes a differential between the angle of the viewer's line of sight toward a row of pixels and the angle of the viewer's line of sight toward the corresponding encoding stripe. Because the procedure for creating the left and right views depends on a precise alignment of the horizontal, vertical, or checkerboard arrangement of encoding stripes with the image pixel matrix, the gap between the encoding material and the image pixel matrix created by the width of the screen glass results in slight distortions in the image perceived by the viewer. These distortions are caused by unintended partial encoding of the row of pixels adjacent to the row positioned directly behind a encoding stripe.

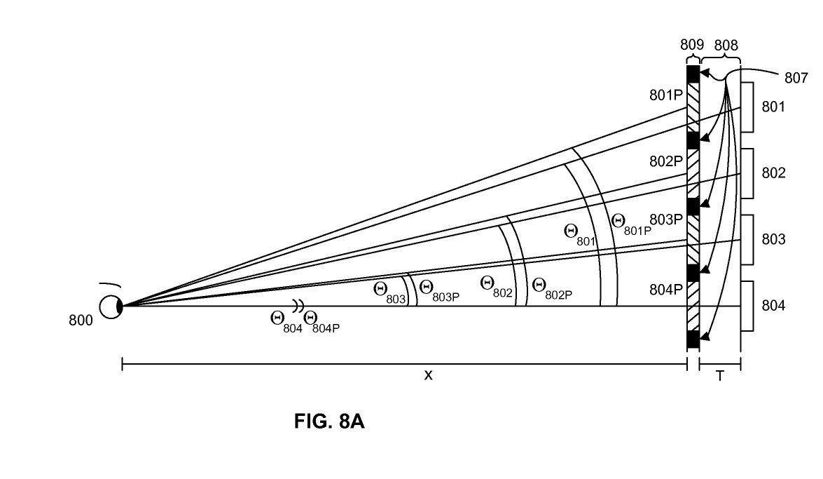

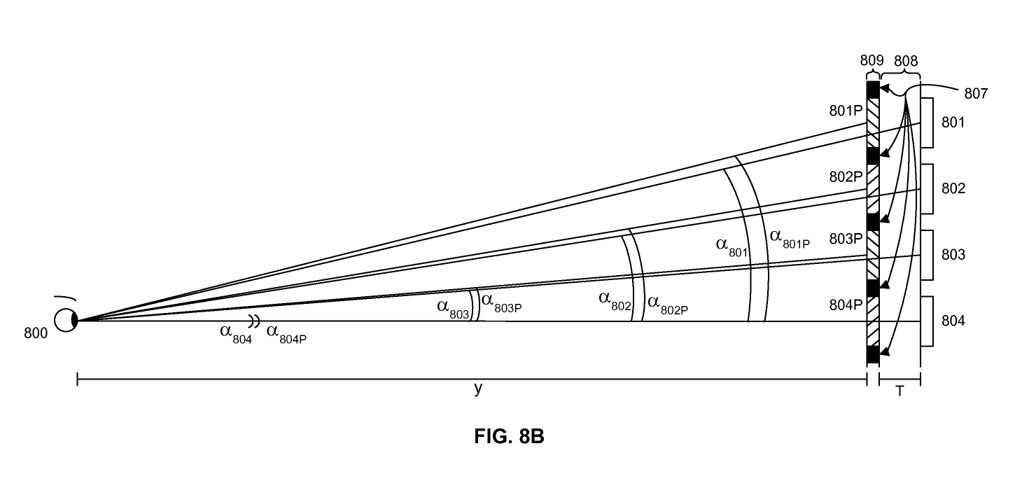

This problem is illustrated in FIGS. 8A and 8B. FIGS. 8A and 8B depict a viewer 800 and a side view of an LCD display 100 layered with a sheet of encoding material 809, wherein the encoding stripes are disposed on a single sheet in a horizontal arrangement. The LCD display comprises a glass screen 808 of thickness T through which horizontal rows of pixels 801, 802, 803, and 804 are displayed. The encoding material comprises black ink stripes 807, left encoding stripes 801P and 803P, and right encoding stripes 802P and 804P. The glass screen causes the encoding material to be separated from the rows of pixels by a distance equivalent to thickness T. In FIG. 8A, the viewer 800 sits at a distance x from the LCD display. In FIG. 8B, the viewer 800 sits at a distance y from the LCD display, wherein y is greater than x. In FIG. 8A, Each row of pixels 801, 802, 803, and 804 is disposed at a particular angle θ₈₀₁, θ₈₀₂, θ₈₀₃, θ₈₀₄ relative to the position of the viewer, and each encoding stripe 801P, 802P , 803P, and 804P is disposed at a particular angle θ_{801P}, θ_{802P}, θ_{803P}, θ_{804P} relative to the position of the viewer, respectively. In FIG. 8B, Each row of pixels 801, 802, 803, and 804 is disposed at a particular angle α₈₀₁, α₈₀₂, α₈₀₃, α₈₀₄ relative to the position of the viewer, and each encoding stripe 801P, 802P , 803P, and 804P is disposed at a particular angle α_{801P}, α_{802P}, α_{803P}, α_{804P} relative to the position of the viewer, respectively.

As shown in each of FIGS. 8A and 8B, the angle of a encoding stripe or row of pixels relative to the viewer is proportional to the distance between the viewer and the encoding stripe or row of pixels. Thus, the angles θ₈₀₄, θ_{804P}, α₈₀₄, and α_{804P} are each 0°. Furthermore, due to distance T, there is a slight differential between the angle of a encoding stripe relative to the viewer and that of a corresponding row of pixels. These angular differentials cause rows of pixels to become partially visible and encoded through encoding stripes covering adjacent rows, resulting in a distortion. Although this distortion may be nonexistent or minimal at, for example, points along the screen near row 804 where the angles θ₈₀₄, θ_{804P}, α₈₀₄, α_{804P} are each 0°, the distortion is more pronounced at points closer to the edges of the display screen where the angular differentials are greater. For example, the bottom portion of row 801, which should only be encoded by left encoding stripe 801P, is inadvertently encoded by right encoding stripe 802P due to the differential between θ₈₀₁ and θ_{801P} or α₈₀₁ and α_{801P}.

Theoretically, simply decreasing the angular differentials might minimize these distortions. However, the angles and their accompanying differentials are inversely proportional to the distance between the viewer and the LCD screen. This is apparent from the smaller angles and angular differentials of FIG. 7B relative to those of FIG. 8A, where the distance y between the viewer 800 and the LCD screen 100 in FIG. 8B is greater than the distance x in FIG. 8A. Consequently, the magnitude of the angles and their angular differentials approaches 0 as the distance between the viewer 800 and the LCD screen 100 approaches infinity, and the effect of the distortion may only be minimized by viewing the LCD screen from a long and potentially undesirable distance.

Thus, the most viable technique for minimizing this distortion is positioning the black stripes 807 such that any row of pixels adjacent to the row being encoded is fully obstructed from view. Consequently, the black stripes should be arranged in a manner that accounts for the angular differentials between the encoding row and pixel row angles.

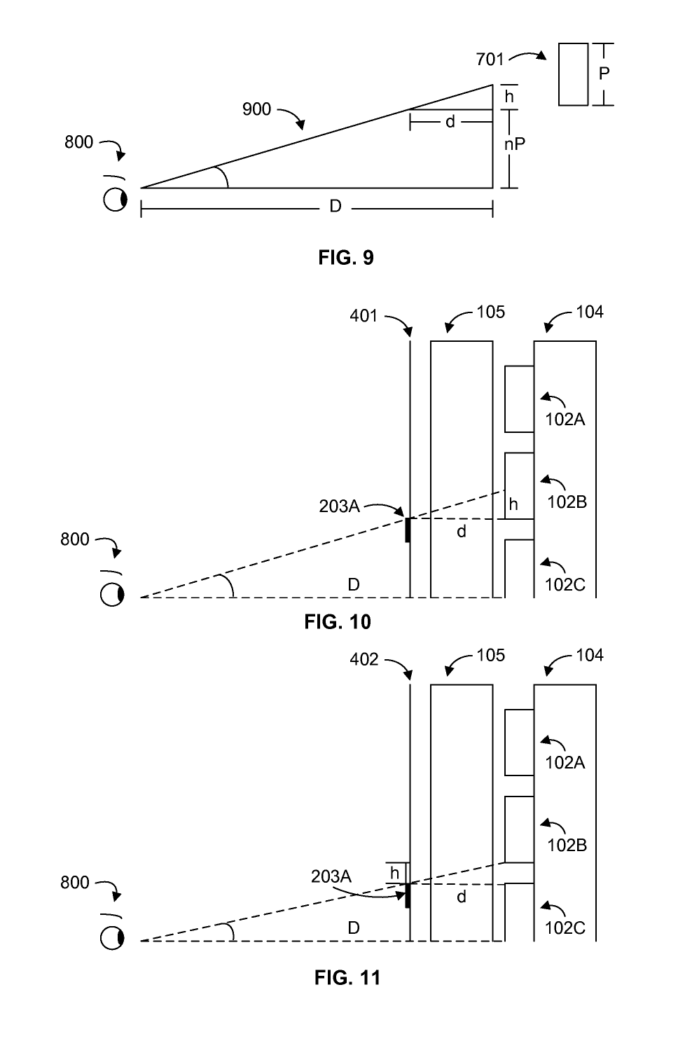

FIG. 9 presents a geometric diagram 900 for calculating the correct position of the black ink stripe as it relates to the position of the viewer 800 and the thickness of the glass between the film and the pixels. A single RGorB pixel element 701 is also depicted to illustrate the source of the measurement P, the height of a single pixel. Other parameters include: the distance d from a black ink stripe 807 to an illuminated pixel in the display 100, the distance D from the viewer 800 to the illuminated pixel in the display 100, and the distance h that the black ink stripe must be moved to correct for the angular viewing error from the viewer 800 to the illuminated pixel in the display 100.

In the present example, the following is required to calculate the correct position of the black ink stripes: distance D, height P, distance d, distance h, and the number of pixels n from the horizontal plane at the center of the display to the vertical or horizontal point along the display adjacent to the viewer's line of sight. K is a constant that is derived from the following: with uncorrected uniform spacing, the positions of the black ink stripes correspond to the height of any pixel multiplied by the number of pixels nP. To correct this error above the center of the horizontal line of sight, the black ink stripe needs to be lowered by h to allow the viewer to see the entire pixel. Below the horizontal line of sight of the black ink stripe, this distance needs to be added, i.e.,

$$\frac{( nP - h )}{D} = \frac{nP}{( D + d )}$$

where (nP−h) and D are the height and base of the view to the black ink stripe and nP and (D+d) are the height and base of the view of the bottom of the pixel. These are similar triangles and the ratios of the distances are equal. Therefore,

$$nP - h = \frac{nPD}{( D + d )}$$

so

$$h = n ( P ( 1 - \frac{D}{( D + d )} ) ) = nK$$

and h=nK and the height of the black ink stripe at the n-th pixel is n(P−K).

FIG. 10 depicts an expanded side plan view of the LCD monitor 104 including the front glass 105, and RGB pixels 101A-C. Also shown is an expanded side plan view of a layer of encoding material 401. The uncorrected position of this stripe is directly in between the pixels 101B and 101C. Also shown is the optical path represented by dashed lines of the distance D from the viewer 800 to LCD pixels 101 C, the distance d from the black ink stripe 203A to the pixel 101B, and the error correction distance h that the black ink strip 203A needs to be shifted.

FIG. 11 presents an expanded side plan view of the LCD monitor 104 including the front glass 105 that is part of the LCD panel and RGB pixels 101A-C. Also shown is an expanded side plan view of the combined layers of film forming a complete product 402 with an expanded thickness for clarity of the position on the film of the first horizontal black ink stripe 203A as shown in FIG. 4. This stripe is now in the correct position and the distance that it has been moved is shown as h; the viewer can now see the entire pixel 101B. Also shown is the optical path represented by dashed lines of the distance D from the viewer 800 to LCD pixels 101C, the distance d from the black ink stripe 203A to the pixel 101B.

The detailed description provided herein is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, refer to this application as a whole and not to any particular portions of this application.

The detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications, if any, are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms.

The claims herein, if any, do not limit the scope of this disclosure, and additional claims may be added to related non provisional patent applications.

What is claimed is:

1. A method for increasing a viewing angle of a three dimensional image displayed from an array of pixels, the method comprising:
receiving an image from an array of pixels formatted in accordance with a three dimensional format; and
positioning encoding material, configured in accordance with the three dimensional format, between the image and a position of a viewer to generate a three dimensional image from the formatted image of the array of pixels relative to a position of a viewer of the three dimensional image and the array of pixels, so as to correct for an angular viewing error.

2. The method as set forth in claim 1, wherein:
positioning encoding material comprises positioning encoding material lower than a corresponding pixel if the position of the viewer comprises a position above a horizontal line of sight measured from the viewer to the pixels.

3. The method as set forth in claim 1, wherein:
positioning encoding material comprises positioning encoding material higher than a corresponding pixel if the position of the viewer comprises a position below a horizontal line of sight measured from the viewer to the pixels.

4. The method as set forth in claim 1, wherein the encoding material comprises:
a right view layer including alternating rows of right view encoding stripes, transparent stripes, and black ink stripes,
a left view layer including alternating rows of left view encoding stripes, transparent stripes, and black ink stripes, and
a lamination layer.

5. The method as set forth in claim 4, wherein positioning the encoding material further comprises:
creating a combined set of layers by affixing the right viewer layer and the left view layer to opposite sides of the lamination layer;
affixing the combined set of layers to a visual display device.

6. The method as set forth in claim 1, wherein the encoding material comprises a single layer including alternating rows of right view encoding stripes, left view encoding stripes, and black ink stripes.

7. The method as set forth in claim 6, wherein positioning the encoding material comprises affixing the single layer to a visual display device.

8. The method as set forth in claim 1, wherein the encoding material comprises sections of polarization ink for polarizing the image to produce a right view image and a left view image.

9. The method as set forth in claim 1, wherein:
the encoding material comprises sections of quarter wave retarders;
the image is linearly polarized;
the quarter wave retarders circuarly polarize the linearly polarized image to produce a right view image and a left view image.

10. The method as set forth in claim 1, further comprising viewing a decoded three dimensional image through a viewing apparatus including a right lens for decoding a right view image and a left lens for decoding a left view image.

11. An apparatus for increasing a viewing angle of a three dimensional image displayed from an array of pixels, comprising:
an array of pixels for illuminating an image formatted in accordance with a three dimensional format; and
an encoder, coupled in proximately to the array of pixels, comprising encoding material for receiving the image from the array of pixels and for encoding the image in accordance with the three dimensional format, wherein the encoding material is positioned, relative to a position of a viewer of the three dimensional image and the array of pixels, so as to correct for an angular viewing error.

12. The apparatus as set forth in claim 9, wherein:
the encoding material is further positioned lower than a corresponding pixel if the position of the viewer comprises a position above a horizontal line of sight measured from the viewer to the pixels.

13. The method as set forth in claim 9, wherein:
the encoding material is further positioned higher than a corresponding pixel if the position of the viewer comprises a position below a horizontal line of sight measured from the viewer to the pixels.

14. The apparatus as set forth in claim 9, wherein the encoding material comprises:
a right view layer including alternating rows of right view encoding stripes, transparent stripes, and black ink stripes,
a left view layer including alternating rows of left view encoding stripes, transparent stripes, and black ink stripes, and
a lamination layer.

15. The apparatus as set forth in claim 12, wherein the encoding material is further positioned by:
creating a combined set of layers by affixing the right viewer layer and the left view layer to opposite sides of the lamination layer;
affixing the combined set of layers to a visual display device.

16. The apparatus as set forth in claim 9, wherein the encoding material comprises a single layer including alternating rows of right view encoding stripes, left view encoding stripes, and black ink stripes.

17. The apparatus as set forth in claim 14, wherein the encoding material is further positioned by affixing the single layer to a visual display device.

18. The apparatus as set forth in claim 9, wherein the encoding material comprises sections of polarization ink for polarizing the image to produce a right view image and a left view image.

19. The apparatus as set forth in claim 9, wherein:
the encoding material comprises sections of quarter wave retarders;
the image is linearly polarized;
the quarter wave retarders circuarly polarize the linearly polarized image to produce a right view image and a left view image.

20. The apparatus as set forth in claim 9, further comprising a viewing apparatus including a right lens for decoding a right view image and a left lens for decoding a left view image, wherein the viewing apparatus is used to view a decoded three dimensional image.
